(19) United States
(12) Patent Application Publication
(10) Pub. No.: US 2003/0088452 A1
(43) Pub. Date: May 8, 2003

(54) Survey methods for handheld computers

(76) Inventor: Kevin James Kelly, Austin, TX (US)

Correspondence Address: Wendy K. Buskop, Buskop Law Group, P.C., Suite 500, 1717 St. James Place, Houston, TX, 77056, US

(21) Appl. No.: 09/874,129

(22) Filed: Jun. 5, 2001

Related U.S. Application Data
(60) Provisional application No. 60/262,915, filed on Jan. 19, 2001.

(51) Int. Cl. G06F 17/60

(52) U.S. Cl. 705/10

(57) ABSTRACT

A method for surveying customers and employees using a handheld computer such as a Symbol SPT 1500 handheld device, a relational database and a server hosting the relational database.

The present application claims priority to provisional patent application Serial No. 60/262,915 filed in the United States Patent and Trademark Office on Jan. 19, 2001.

### BACKGROUND OF THE INVENTION

Companies need surveys for obtaining feedback from clients regarding their products and services as well as obtaining data on various operational metrics. These surveys often enhance strategic and competitive advantages for the company reviewing and analyzing the data. It has been difficult in the past to collect “instant” feedback from customers, as it has traditionally required writing down of information, and question and answer between an employee of the company and the customer. This problem is particularly difficult for service-based companies such as fractional jet ownership operators and others, where limited customer to employee interaction occurs, but extensive customer to “goods” or “related services” interaction occurs.

A method has long been needed which increases operational efficiencies of fleet owners and other service-based industries in obtaining survey information and customer feedback which eliminates data errors, maximizes corporate profits and leverages existing enterprise level infrastructure.

The present invention relates to a software tool that permits creation of electronic surveys and the collection and tabulation of survey results corresponding to user responses based on customizable criteria.

Using the tool, a survey is created on a hand held computer and then communicated to a database, by the Internet, or by conventional means. A client, can then access the database to obtain the results. Survey results are initially collected in a relational database on the hand held as each user completes the survey and then transmits in batch or individually to the main database. Thereafter, statistical tools or other analytical software applications may be applied to data mine the tabulated results. In another preferred embodiment, the software tool is utilized to access remote servers running relational databases from an Internet computer via the Web. Advantageously, the computer does not require the computational processor power or memory (i.e. system memory or disk storage capacity) normally required to load and operate the applicable relational database application software.

### SUMMARY OF THE INVENTION

A computer system for performing a survey using a handheld computer, the hand held computer being connectible to a network link to a server computer, the computer system comprising: a network server system disposed in the server computer; a browser disposed in the client computer, the browser for accessing the network server system; and a hand held computer; a dynamic survey system residing on the handheld computer, the dynamic survey system adapted to allow users to construct survey questions for a plurality of surveys on the handheld computer, the dynamic survey system further adapted to present the survey on the handheld, and obtain data relative to the survey, the dynamic survey system further adapted to enable the users to access results of the survey located on the server system using the client computer without requiring the client computer to have a second survey system disposed therein, the dynamic survey system adapted to provide a new survey from a decision tree having a plurality of available surveys if an appropriate response to a previously answered survey question is provided in a first survey.

### BRIEF DESCRIPTION OF THE FIGURES

FIG. 1 is an exemplary screen showing the start of the survey method on a handheld computer;

FIG. 2 is an exemplary screen showing the text, which is presented to customers using the survey method of the invention;

FIG. 3 is an exemplary screen showing typical preflight questions, which can be presented to customers using the survey method of this invention;

FIG. 4 is an exemplary thank you screen for use on the customer's survey of the invention;

FIG. 5 is an exemplary password screen for the employee data entry portion of the survey method of the invention;

FIG. 6 is an exemplary crew departure screen, specifically the tail number entry screen for crew use in the survey method of the invention;

FIG. 7 is an exemplary flight information screen, specifically the date of the flight screen for crew use within the scope of the invention;

FIG. 8 is an exemplary thank you screen for crew using the survey method of the invention;

FIG. 9 is a comparison of the traditional method verses that of this invention; and

FIG. 10 is a flowchart representing the user workflow for the optional authoring tool component of the invention.

### DETAILED DESCRIPTION OF THE INVENTION

The present invention relates to a method for surveying customers and employees using a portable computer, specifically, a handheld computer such as a Symbol SPT 1500 handheld device. The invention is targeted for companies and organizations that are interested in capturing feedback from customers and employees, both internally and externally. It is a system that endeavors to be flexible yet very powerful in the information that it allows one to capture in an effort to allow one to improve upon and enhance a company's core line of business.

The method involves asking a series of questions of an individual using a handheld computer so that the answers can be electronically loaded into a database. The handheld component of the product is targeted at the Palm OSTM product platform while the enterprise back end is designed to run on Microsoft Windows based platforms.

The invention is designed to run on a handheld Palm OS™ computing platform compatible devices while utilizing the wireless data transport mechanism of the Palm VII™ family of products for the purposes of wirelessly transmitting survey data. The handheld devices that the invention should run on include the Palm III™, Palm IIIx™, Palm IIIxe™, Palm IIIe™, Palm IIIc™, Palm V™, Palm VII™, Palm VIIx™, IBM Workpad™, TRGPro, Symbol SPT1500 and any other Palm OS™ powered handheld computer.

The invention relates to a system for performing surveys regarding services comprising:

(a) a handheld computer;

(b) data acquisition software for the handheld computer, designed to permit customers to enter data on the handheld computer designed to offer a plurality of customizable questions regarding the services comprising:

(i) identification data for the customer;

(ii) questions regarding the services;

(iii) employee identification data for employees providing the services; and

(iv) questions regarding the services;

(c) interface software on the handheld computer transmit the data acquired on the handheld computer from the hand held computer to a database; and

(d) report software wherein database reports can be produced from the database.

The invention relates to a computer system for performing a survey using a handheld computer, the hand held computer being connectable to a network link to a server computer, the computer system comprising: a network server system disposed in the server computer; a browser disposed in a client's computer, the browser for accessing the network server system; a handheld computer; and a dynamic survey system residing on the handheld computer, the dynamic survey system adapted to allow users to construct survey questions for a plurality of surveys on the handheld computer, the dynamic survey system further adapted to present the survey on the handheld computer, and obtain data relative to the survey, the dynamic survey system further adapted to enable the users to access results of the survey located on the server computer using the client computer without requiring the client computer to have a second survey system disposed therein, the dynamic survey system adapted to provide a new survey from a decision tree having a plurality of available surveys if an appropriate response to a previously answered survey question is provided in a first survey.

It is contemplated to be within the scope of the invention that the survey data can be collected on a palm computer, a Visor or Sony handheld computer, and then the data can be transmitted by connecting to a web page that connects to a network server.

Each handheld computer used in the survey comprises software scripts for generating a survey question on the handheld computer. These scripts can be customized or otherwise modified to meet each customer's need.

The computer system can further comprise an authorization system for selectively providing access to the software scripts such that the handheld computer for a client provides client questions when authorized, and the handheld computer provides employee questions when authorized.

The invention contemplates a survey system, which further comprises an authorization system for selectively providing access to the survey results.

The system is contemplated to comprises a relational database system adapted to tabulate the results of a survey presented by the handheld computer such that a client can access the relational database tabulated survey results can view what the customers and the employees have given as responses.

In still another embodiment, of the invention, it is contemplated that a network able computer system could be used wherein a handheld computer having a CPU, a memory, a browser, a display device and an input device can be used to conduct an electronic survey comprising software scripts for generating at least one page displayable handheld computer wherein that page comprises a plurality of survey questions accessible by the browser; and a relational database application resident in the memory of a second computer which can communicate with the handheld computer. The relational database application can have a plurality of tables for storing a plurality of surveys. The invention contemplates that the electronic survey can be adapted to provide a new survey from a decision tree having a plurality of available surveys if an appropriate response to a previously answered survey question is provided in a first survey.

If a networkable computer system is the embodiment, the invention contemplates storing responses to the survey questions in tables and for summarizing and presenting results of those responses to the questions. In this embodiment, a second computer having a second CPU, a second memory, a second display device and a second input device, are contemplated as well, that is, a plurality of handhelds can be simultaneously obtaining data and downloading the data to the main server with the relational database. The additional handhelds are contemplated as being network able with the first handheld computer by an interface. Each handheld would have a similar configuration, wherein each computer would have a browser resident in the second memory for accessing responses to the survey questions. The responses would be stored in at least one of the tables resident in the memory of the second computer.

Also it is contemplated that one handheld could transfer information, tables and data to another handheld without requiring the second computer to have a survey system disposed on it as well.

The invention contemplates that the electronic survey can in a sense, be self modifying, that is, the handheld could be programmed that based on certain survey results, the handheld would then select different questions to provide to the user, that is, the survey would be dynamically modified by adding data or data tables.

The invention relates not only to the equipment and software, but also to a method for conducting a survey using a handheld computer comprising: configuring a relational database environment such as with a plurality of data tables, populating at least one of the data tables with survey questions in response to input from a handheld computer for a survey creator; displaying the survey questions on the handheld computer; viewing the survey questions with the handheld computer by a survey taker; receiving input to the survey questions via the handheld computer; transferring the data from the survey questions to a computer having the relational database environment; and providing a new survey from a decision tree having a plurality of available surveys if an appropriate response to a previously answered survey question is provided in a first survey.

This method an be enhanced by the additional step of: notifying users of the survey data that surveys are complete, such as by email over the Internet; and possibly storing the input in a tables or on another computer, or on a computer which can be accessed by the Internet; and tabulating results of electronic surveys.

The method could even further comprising the steps of: receiving further input responsive to a second set of survey questions, such as from a second computer; and accessing the relational database and the data tables in response to this new, further input.

The invention contemplates many types of users having limited or full access to the data tables of the relational database, or no access, and only access to their own questions to the survey. Accordingly, the method contemplates the step of transmitting at least a selected portion of the accessed table either to the user of the handheld, if a proper security code is presented, to the client who requested the survey information, to an employee of the client who needs select information to improve service or similar components being evaluated by the survey.

Spell check is contemplated as a further optional step for the survey, wherein the client or survey designer can further checking the survey questions for correct syntax; the survey designer or creator can be prompted to correct a survey question having an incorrect syntax. A similar feature is contemplated for users who respond in more than yes or no, or numerical answers to their survey questions.

The method contemplates various other features, such as discarding an input to a survey question if it is a null answer.

In another embodiment of the invention, it is contemplated that a survey system has a server with a memory and network connections to a handheld computer, the server has application software, including a relational database, resident in the memory, a method for invoking application software from a handheld computer connected to the server by the network connections, which can include wireless network connections, and wherein the method comprises: presenting a sequence of surveys, stored in a relational database; receiving data via the network or similar wireless connection, inputting data to the surveys; analyzing the input; and responsive to an analysis of the input, invoking application software to dynamically provide a new survey from a decision tree having a plurality of available surveys if an appropriate response to a previously answered survey question is provided in a first survey. This method further contemplates the steps of: receiving, via the network or wireless connection, input to a second sequence of surveys, such as from a second handheld computer; analyzing that input; and responding to that analysis of input. As with the other system, this method contemplates that adding an additional survey to the sequence of surveys can dynamically modify the surveys.

The invention authoring tool component that can work as a personal computer web-based tool, a tool for use with the Internet or similar corporate intranets or other global communication networks, to allow the company or organization to create, modify and author surveys for distribution to the handheld platform. The tool allows the administrative agent of the company or organization to securely log in and create or modify or otherwise change a survey and all of its associated questions and appropriate questions for each answer. Once a survey has been completely authored, it can be downloaded using a survey-publishing agent for electronic distribution using a variety of means such as email or floppy disk.

The authoring tool can connect to the survey-publishing agent, which has a wide area synchronization feature that connects a plurality of handheld computers together. So not only can input come into the system from a plurality of handhelds, but results can be re-broadcast to a plurality of handhelds.

The invention captures data into the system using questions segregated for customers and employees or any other target audience. The questions may be of differing types such as, textual questions, where the user may enter textual information in standard alphanumeric formats, numeric questions, where the user may enter a numeric response to the questions having associated minimum values, maximum values and numbers of decimal places.

In the most preferred embodiment, the questions will be distinct types: textual questions, allowing the user to enter textual based information, numeric questions, allowing the user to enter numeric information, single selection questions, allowing the user to choose a single selection from a list of up to six options, multiple selection questions, allowing the user to choose multiple selections from a list of up to six options, date questions allowing the user to specify a date, absolute time questions allowing the user to specify and absolute time, and elapsed time questions, allowing the user to specify an amount of elapsed time. The field service embodiment of the invention contemplates using associated minimum values, maximum values and numbers of decimal places. Additionally, there is a password type of question that requires the user to enter the proper password to continue with the survey. The final type of question is a navigational question, which displays non-editable text to the user and has an associated point in the method to which the system subsequently jumps into. Any question may be optional or required. In addition, a question may have several possible answers to select from. Each of these answers, in turn, can take the user to the next question in the sequence; furthermore, each answer may lead the survey through a different sequence (e.g. if one answers “yes” to a question, one could be directed to another question requesting additional information; however, if one answers “no” to that same question no additional information would be requested). For example, if a customer is asked how the catering on a flight was, if the answer selected is “unacceptable”, then a series of additional screens would be presented to the customer to gather additional information such as questions concerning food temperature, presentation, and cleanliness of the silverware. Additionally, “continue” and “next” buttons are used on the screen to lead the user forward through the survey. Similarly, a “previous” or “back” button on the screen is contemplated to allow the user to navigate towards the beginning of the survey or review previously answered questions. Optionally, each screen may have an “i” icon perhaps in the corner of the screen. This “i” icon indicates that there is additional information related to that particular question. For example, the “i” icon may provide this user with additional instructions or context regarding the specific question or its relevance. It is contemplated that historical information on the vehicle, such as the aircraft, could be loaded for the user to review.

Additionally, in the preferred embodiment, the survey can capture the date and time that the survey began and the time that it was completed.

Once a survey is completed, the results from the survey can be transmitted via the Internet or beamed from one handheld to another or downloaded into a personal computer. If the Internet embodiment is used, the survey results are placed in an email message that is placed in the “outbox” of the native email application for transmission to the corporate offices for processing. In the case of the Palm VII™, this is the iMessenger application, and the email message may be wirelessly transmitted. This transmission will require an employee to raise the antenna of the Palm VII™ and press a button on the screen. All surveys then will be automatically sent. Additionally, survey results could be transmitted off of the handheld device using a synchronization process, such as the Palm HotSync® data synchronization process.

In the most preferred embodiment of the present invention, the questions can be developed for use in the fractional jet ownership sector. Specifically, a fractional jet owner may be interested in the answers to specific questions relating to the flight in the categories of pre-flight, which are questions about booking, reservations and other preflight issues, aircraft and crew, which relate to questions on the aircraft and crew, flight which are questions specific to the flight, catering, which are questions specific to the catering, and closing, which would be questions specific to the owner, on how you would like to be contacted on this survey.

The crew specific questions can be on departure, which would be questions about the departure, such as was it on time, catering, such as questions specific to the food, and silverware, transportation, which would be about the owner's ground transportation and closing, which would be specific to the crew, such as how would you like to be contacted.

The crew or employee may have questions for the end of the day, which include flight information, related to the flights and flight plans, hotel information, which includes questions relating to the hotel, catering which relate to the food service and closing questions specific to the end of a flight.

Typical questions for a flight situation appear below:

Pre-Flight Section

Would you like to participate in the survey?

The Owner Services Representative conducted himself/herself in a professional manner when scheduling my trip.

The representative had the technical knowledge to meet my expectations in scheduling my trip.

I received a timely confirmation itinerary of my trip.

I received an accurate itinerary prior to my trip.

Aircraft & Crew Section

The Pilot & Crew conducted themselves in a professional manner.

The interior of my aircraft was orderly and clean.

The air show, audio, TV and phone systems were in working order.

Flight Section

The aircraft was ready to depart at the scheduled departure time.

I requested catering on my flight.

Catering Section

I was satisfied with the accuracy the catering.

Please select the reasons why the accuracy of your catering was not satisfactory.

I was satisfied with the quantity of the catering.

Please select the reasons why the quantity of your catering was not satisfactory.

How would you rate the presentation of your catering? (Please use range.)

How would you rate the quality of your catering? (Please use range.)

Closing Section

I would like to be contacted regarding my flight today.

Would you like to provide additional comments regarding your flight today?

Comments

Thank you

Crew Survey Section

Would you like to take the crew portion of the flight survey?

Please enter your crew password.

Crew Departure Section

Please fill in the following entries

Did you depart at the scheduled departure time?

What was the length of the delay?

What was the primary reason for the delay?

What was the reason for the Flexjet delay?

What was the reason for the Vendor delay?

Was catering ordered on this leg?

Crew Catering Section

Owner was satisfied with the accuracy of the catering.

Please select the reasons why the accuracy of your catering was not satisfactory.

Owner was satisfied with the quantity of the catering.

Please select the reason why the quantity of the catering was not satisfactory.

How would you rate the presentation of the catering? (Please use range.)

How would you rate the quality of the catering? (Please use range.)

Crew Transportation Section

Was ground transportation requested through FlexJet?

What type of ground transportation did the owner request?

Were you able to obtain ground transportation for arrival?

Was the ground transportation at the airport upon arrival?

If known, what was the reason?

Crew Closing

Would you like to be contacted by a Crew Relations Representative?

I would like to provide additional comments regarding the flight today.

Comments

What date was the flight?

Thank You

Do you wish to take the crew end of day survey now?

Flight Information

What date was the flight?

Please enter the following information

Were any of your flights (Position or Live Legs) during one of the following time periods? (Select all that apply.)

The Flight Plan and/or Revisions were:

Was the Flight Plan accurate?

The Trip Sheet and/or Revisions were:

Was the Trip Sheet accurate?

Flight Control Representative conducted him/herself in a professional manner.

Airline reservations were:

Hotel Information

Hotel reservations were:

How would you rate the location of the hotel?

How would you rate the food service of the hotel?

I was satisfied with the overall hotel accommodation.

Catering

Did you receive catering today?

I was satisfied with the accuracy of the catering.

Please select the reasons why the accuracy of your catering was not satisfactory.

I was satisfied with the quantity of the catering.

Please select the reasons why the quantity of the catering was not satisfactory.

How would you rate the presentation of your catering? (Please use range.)

How would you rate the quality of your catering? (Please use range.)

Would you like to provide additional comments?

Comments?

Additional components to the system may include a survey system data store targeted to be the Company's server database, although any data store can be used. It is also contemplated that a Microsoft exchange agent and be used and be responsible for transferring information received from the email box that collects the field data into the Survey System Data store.

Once the survey is complete, it is contemplated that the results are emailed to a corporate data center. The email results can be received and analyzed by a Microsoft Exchange Agent that parses the results of the submitted survey and interests them into a Microsoft SQL Server database. Once the results are in the database, standard corporate reporting procedures and tools can analyze them.

Additionally, it is contemplated that the invention could gather survey results using audio (i.e. voice) and video (e.g. still photos, video) data capture. Furthermore, it is contemplated that the invention could operate on additional handheld devices other than those based on Palm OS™ such as Microsoft Pocket PC, for example.

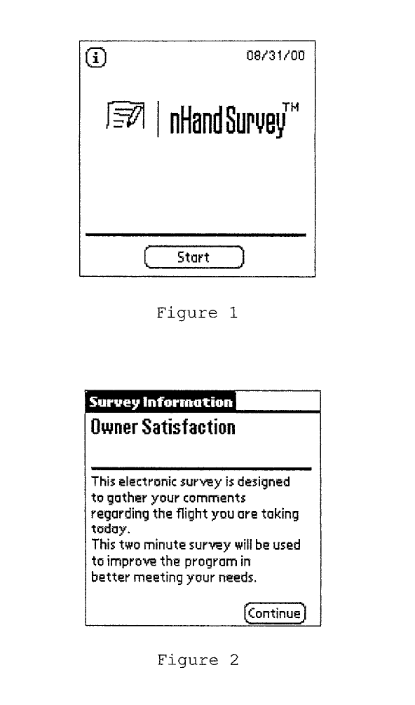

FIG. 1 is the first screen for a fractional jet owner's survey. This screen has blocks for the application logo, the name and logo of the client corporation, an “i” icon which leads to the application's “about” screen, the current date, a “start” button, and a hidden “preferences” button. The preferences button is hidden behind the application logo and leads to a setup screen which can be password protected and allows the user to enter or view the name of the survey, as well as survey-specific information such as its unique code, the version number, the email address to send results to, and checkboxes that determine whether alpha and numeric pop-up keyboards are in use, whether the Palm VII™ iMessenger application is used for data transmission, whether partial (i.e. incomplete) survey results are to be retained, and whether to show an “end survey” button on each screen. The “start” button can default to a pre-selected survey architecture or lead the user to an additional screen to select which survey to conduct. Once a survey is selected then an icon on the survey select screen can lead the user to the beginning of the series of questions for that survey.

FIG. 2 displays some introductory information to the user on the survey. The screen has text a “continue” button that allows the user to advance to the next screen. Any question that is entered into the survey can be configured to be the initial starting question for that survey. It is contemplated that the questions can be re-ordered depending on the desired relevance of each question. Typical textual information would be an explanation of the purpose of the survey, the time it should take to complete the survey and perhaps a statement indicating the benefits of the survey and survey results to the user.

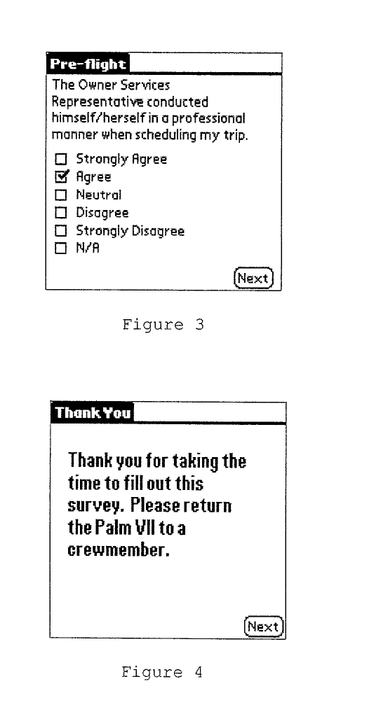

FIG. 3 is the initial question screen in the survey. This question is a typical question in a survey and can be any of the types of questions enumerated above. This figure shows a check box method of answering the question; however, in this invention, other methods could be used on the screen such as free form textual answers, numeric value answers, date answers, time answers or similar methods. The screen may additionally include a “next” button that allows the user to advance to the next question or a conclusion screen.

FIG. 4 is the conclusion screen of one part of the survey. This screen provides concluding information to the user. Typical information might include thanking the user for conducting the survey and providing additional instructions. A “next” button on the screen allows for the user to advance to the next portion of the survey. It is contemplated that additional buttons and functions could be incorporated here such as a button to print a coupon, a button for a free phone call or similar functions to reward the user for completing the survey.

FIG. 5 is a screen that requires password entry to proceed with the survey. The correct password must be entered to continue to the restricted section. In this figure, the screen shows a request for a “crew password”; however, a “mechanic password” or other employee password could be encoded depending on the application of the survey. A “next” button allows the user to proceed into the restricted section if the correct password has been entered; if an incorrect password has been entered, the user is presented with an appropriate error message.

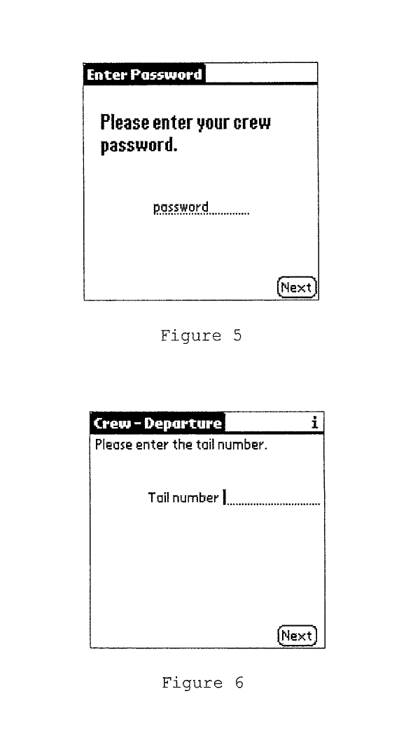

FIG. 6 is a screen representing a question regarding the tail number of a plane. This question is using the free form text data capture method to record the data. However, other methods of data capturing the vessel identification number could be utilized. A “next” button allows the user to proceed to the next question.

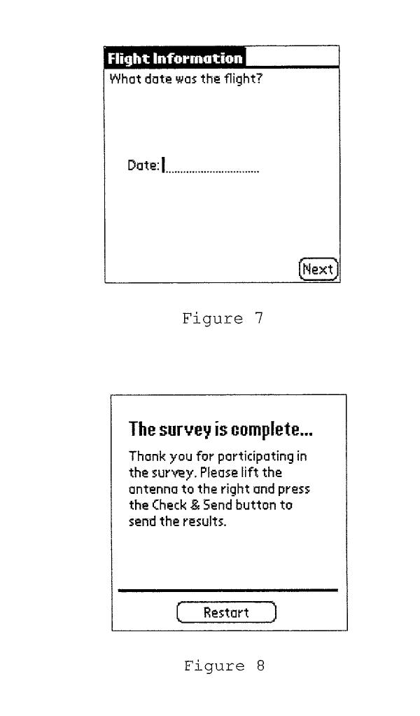

FIG. 7 is a screen representing a question regarding the date of the flight that the survey is being conducted for. This question is using the date data capture method to record the data. Touching this date field will display a calendar to the user so that a date may be selected; this calendar is an optional feature of the survey. Other methods of data capturing flight details could be utilized. A “next” button allows the user to proceed to the next question.

FIG. 8 is the concluding screen for the entire survey. It contains closing instructions for the user as well as a “restart” button. Typically the “restart” button is used to restart or initiate a new survey. Additional buttons could be added to delete entire survey results if desired. Typical text for the closing instructions might instruct the user on how to wirelessly send the survey results to the corporate computer for compilation or storage or provide additional information.

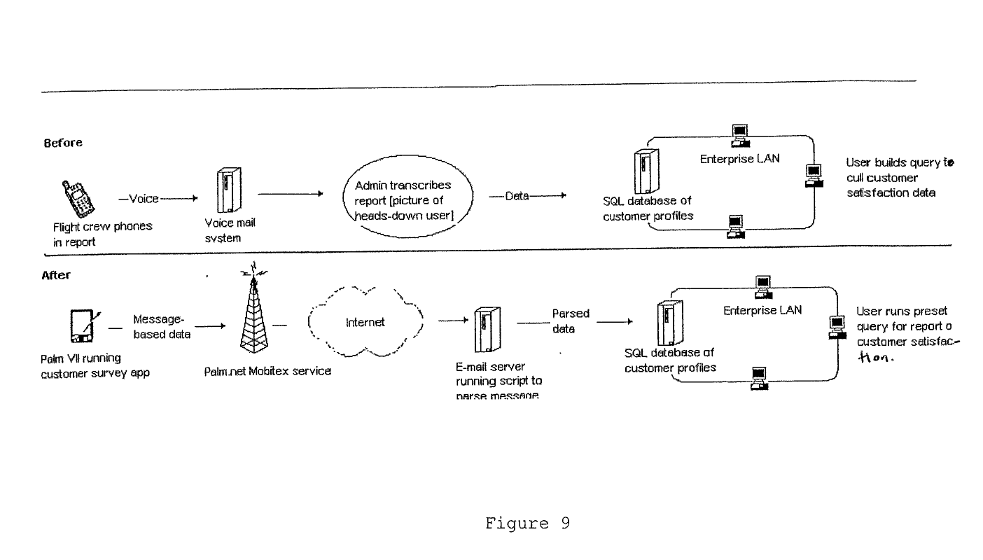

FIG. 9 shows a comparison between a typical phoned in survey and the method of this invention. Specifically, in this invention, the Palm VII™ runs the survey application.

The wirelessly transmitted using a network capable of wirelessly transmitting and receiving the survey, such as the Mobitex service available from Palm.net™. Once the Internet service has received the message, it is emailed to the corporate server as configured in the survey. This server parses the results of the survey and transmits the data to be stored in a corporate database. The corporate database is preferably a standard SQL database of customer profiles. The SQL database is connected to the enterprise LAN allows administrative users to access the database to produce pre-configured reports on customer satisfaction or other desired information.

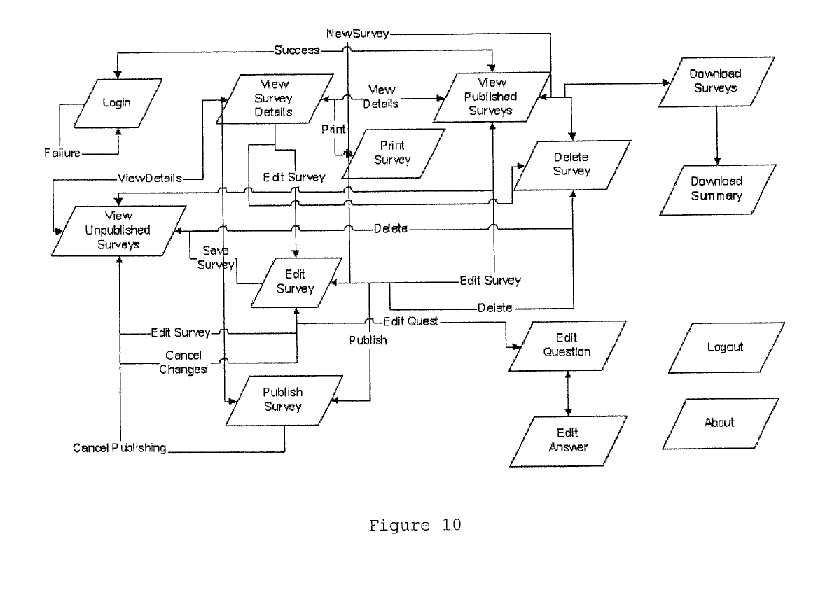

FIG. 10 displays a flowchart representing the workflow of the optional web-based authoring tool. The parallelograms represent application screens that the user can interact with from within a web browser such as Netscape Navigator or Microsoft Internet Explorer; the directional lines represent specific actions taken by the user. For example, the directional line labeled “Success” from the “Login” parallelogram to the “View Published Surveys” parallelogram represents a successful login by the users.

In the most preferred embodiment of this invention for the fractional jet ownership example, the software should cost less than half the price of the conventional survey technique shown in FIG. 9. Additionally, the invention operates significantly faster than the conventional technique, allowing the customer to attain survey results and feedback in a near real-time manner where the conventional technique could take up to a week to receive feedback—a potential decrease in delivery time of seven days. Furthermore, the invention substantially improves the reliability of the information captured over the conventional method by at least 25% because the data entry is direct from the user and does not require an intermediary to transcribe the information.

Other uses of this invention could be in the hospitality industry, other areas of the transportation industry, the healthcare industry or in the communications industry to obtain customer feedback. Additionally, it can be used in any setting to obtain quality assurance data regarding one's product(s) and/or service(s). It can also be used in education and training as a testing mechanism to present a series of questions and answers to the user in a methodical manner.

Having thus described a preferred embodiment of the data communication system, it should be apparent to those skilled in the art that certain advantages of the described system have been achieved. It should also be appreciated that various modifications, adaptations, and alternative embodiments thereof may be made within the scope and spirit of the present invention. The invention is further defined by the following claims.

What is claimed is:

1. A system for performing surveys regarding services comprising:
(e) a handheld computer;
(f) data acquisition software for the handheld computer, designed to permit customers to enter data on the handheld computer designed to offer a plurality of customizable questions regarding the services comprising:
(i) identification data for the customer;
(ii) questions regarding the services;
(iii) employee identification data for employees providing the services; and
(iv) questions regarding the services;
(g) interface software on the handheld computer transmit the data acquired on the handheld computer from the hand held computer to a database; and
(h) report software wherein database reports can be produced from the database.

2. A computer system for performing a survey using a handheld computer, the hand held computer being connectable to a network link to a server computer, the computer system comprising:
a network server system disposed in the server computer;
a browser disposed in a client's computer, the browser for accessing the network server system;
a handheld computer; and
a dynamic survey system residing on the handheld computer, the dynamic survey system adapted to allow users to construct survey questions for a plurality of surveys on the handheld computer, the dynamic survey system further adapted to present the survey on the handheld computer, and obtain data relative to the survey, the dynamic survey system further adapted to enable the users to access results of the survey located on the server computer using the client computer without requiring the client computer to have a second survey system disposed therein, the dynamic survey system adapted to provide a new survey from a decision tree having a plurality of available surveys if an appropriate response to a previously answered survey question is provided in a first survey.

3. The computer system of claim 2, wherein the network server system further comprises a web page.

4. The computer system of claim 2, wherein the handheld computer further comprises software scripts for generating a survey question on the handheld computer.

5. The computer system of claim 4, wherein the system further comprises an authorization system for selectively providing access to the software scripts such that the handheld computer for a client provides client questions when authorized, and the handheld computer provides employee questions when authorized.

6. The computer system of claim 2, wherein the system further comprises an authorization system for selectively providing access to the survey results.

7. The computer system of claim 2, wherein the system further comprises a relational database system adapted to tabulate the results to the survey presented by the handheld computer such that a client can access the relational database tabulated survey results.

8. A networkable computer system having a handheld computer, the handheld computer having a CPU, a memory, a browser, a display device and an input device and a means for conducting an electronic survey comprising software scripts for generating at least one page displayable handheld computer wherein the page comprises a plurality of survey questions accessible by the browser; and a relational database application resident in the memory of a second computer, the relational database application having a plurality of tables for storing a plurality of surveys, the electronic survey adapted to provide a new survey from a decision tree having a plurality of available surveys if an appropriate response to a previously answered survey question is provided in a first survey.

9. The networkable computer system of claim 8, further comprising storing responses to the survey questions in the tables and for summarizing and presenting results of the responses to the questions.

10. The networkable computer system of claim 8, further comprising a second computer having a second CPU, a second memory, a second display device and a second input device, and the second computer is networkable with the handheld computer by an interface, the second computer further having a second browser resident in the second memory for accessing responses to the survey questions, the responses stored in at least one of the tables resident in the memory of the second computer.

11. The networkable computer system of claim 10, further comprising means for selecting at least one of the tables and for transferring selected information stored in the tables to the display of the second computer without requiring the second computer to have a survey system disposed therein.

12. The networked computer system of claim 8, wherein the electronic survey is dynamically modified by adding at least one of the plurality of tables.

13. The networked computer system of claim 8, wherein the electronic survey is dynamically modified by modifying at least one of the plurality of tables.

14. A method for conducting a survey using a handheld computer comprising:
configuring a plurality of tables in a relational database environment;
populating at least one of the plurality of tables with survey questions in response to input from a handheld computer for a survey creator;
displaying the survey questions on the handheld computer;
viewing the survey questions with the handheld computer by a survey taker;
receiving input to the survey questions via the handheld computer;
transferring the data from the survey questions to a server having the relational database environment; and
providing a new survey from a decision tree having a plurality of available surveys if an appropriate response to a previously answered survey question is provided in a first survey.

15. The method of claim 14, further comprising the steps of:
notifying users of the survey data that surveys are complete; and
storing the input in at least a different one of the plurality of tables; and
tabulating results of electronic surveys.

16. The method of claim 14, further comprising the steps of:
receiving further input responsive to a second set of survey questions from the new survey; and
accessing one of the plurality of tables in response to the further input.

17. The method of claim 16, further comprising the step of modifying the data set contained in the table selected in response to the further input.

18. The method of claim 16, further comprising the step of transmitting at least a selected portion of the accessed table.

19. The method recited in claim 14, further comprising the steps of:
checking the survey questions for correct syntax; and
prompting the survey creator to correct a survey question having an incorrect syntax.

20. The method recited in claim 14, further comprising the steps of:
discarding the input to the survey question if it is a null answer.

21. In a system having a server with a memory and network connections to a handheld computer, the server having application software, including a relational database, resident in the memory, a method for invoking the application software from a handheld computer connected to the server by the network connections, the method comprising:
presenting a sequence of surveys, stored in the relational database;
receiving data via the network connection, inputting data to the sequence of surveys;
analyzing the input; and
responsive to the analysis of the input, invoking the application software to dynamically provide a new survey from a decision tree having a plurality of available surveys if an appropriate response to a previously answered survey question is provided in a first survey.

22. The method of claim 21, further comprising the steps of:
receiving, via the network connection, input to the second sequence of surveys;
analyzing the input; and
responsive to the analysis of the input, initiating operational functions of the application software.

23. The method of claim 21, wherein the sequence of surveys is dynamically modified by adding an additional survey to the sequence of surveys.

24. The method of claim 21, wherein the sequence of surveys is dynamically modified by modifying at least one of the sequence of surveys.
